(19) United States
(12) Patent Application Publication
(10) Pub. No.: US 2025/0164376 A1
(43) Pub. Date: May 22, 2025

(54) INFORMATION PROCESSING APPARATUS, INFORMATION PROCESSING METHOD, AND PROGRAM

(71) Applicant: Sony Group Corporation, Tokyo (JP)

(72) Inventors: Rei Murata, Kanagawa (JP); Kenji Yamane, Kanagawa (JP); Junichiro Enoki, Tokyo (JP)

(73) Assignee: Sony Group Corporation, Tokyo (JP)

(21) Appl. No.: 19/029,448

(22) Filed: Jan. 17, 2025

Related U.S. Application Data
(63) Continuation of application No. 17/292,998, filed on May 11, 2021.

(30) Foreign Application Priority Data
Nov. 16, 2018 (JP) 2018-215289

(51) Int. Cl. G01N 15/1429; G01N 15/10; G01N 15/14; G06F 3/14; G06F 16/28

(52) U.S. Cl. CPC G01N 15/1429; G01N 15/1459; G06F 3/14; G06F 16/285; G01N 2015/1006; G01N 2015/1477

(57) ABSTRACT

To provide an information processing apparatus, at least one non-transitory computer-readable storage medium, and a method which evaluate the appropriateness of a clustering result in consideration of characteristics of multidimensional data to be clustered.

An information processing apparatus comprising: at least one hardware processor; and at least one non-transitory computer-readable storage medium storing processor-executable instructions that, when executed by the at least one hardware processor, cause the at least one hardware processor to perform: receiving multidimensional data obtained from a plurality of cells; clustering the multidimensional data to generate clustering results indicating a plurality of clusters including a first cluster and a second cluster that share at least a portion of the multidimensional data; and outputting information representing reliability of the clustering results, wherein the information is indicative of a relationship between the first cluster and the second cluster.

### CROSS REFERENCE TO RELATED APPLICATIONS

This application claims the benefit under 35 U.S.C. § 120 as a continuation application of U.S. application Ser. No. 17/292,998, filed on May 11, 2021, which claims the benefit under 35 U.S.C. § 371 as a U.S. National Stage Entry of International Application No. PCT/JP2019/044923, filed in the Japanese Patent Office as a Receiving Office on Nov. 15, 2019, which claims priority to Japanese Priority Patent Application Number JP 2018-215289 filed in the Japanese Patent Office on November 16, 2018, each of which is hereby incorporated by reference in its entirety.

### TECHNICAL FIELD

The present disclosure relates to an information processing apparatus, an information processing method, and a program.

### BACKGROUND ART

In the field of medicine, biochemistry, or the like, it is common to use a flow cytometer to rapidly analyze characteristics of a large number of cells. A flow cytometer is a device that optically analyzes characteristics of cells by irradiating the cells flowing through a flow cell with light beams and detecting fluorescence, scattered light, or the like, emitted from the cells.

Here, data measured by the flow cytometer is multidimensional data including intensity information of fluorescence of a plurality of colors. It is important to evaluate such multidimensional data from a plurality of points of view, but with the increase in the number of dimensions, it has been difficult to analyze the data by human hand.

Therefore, the analysis of multidimensional data measured by the flow cytometer by clustering technology has been considered. The clustering technology is a technology that uses machine learning to divide a target set into subsets in which internal connection and external separation are achieved. By using the clustering technology, it is possible to divide a large number of cells analyzed by the flow cytometer into a plurality of cell groups.

For example, PTL 1 below discloses an example of the clustering technology for clustering data measured by a flow cytometer.

### CITATION LIST

### Patent Literature

[PTL 1]

US Patent Application Publication No. 2013/0060775

### SUMMARY

### Technical Problem

In a case where the result of measurement using the flow cytometer is analyzed by the clustering technology, it is important to consider the characteristics of multidimensional data measured by the flow cytometer. On the other hand, since the clustering technology is an unsupervised learning method, it is difficult to evaluate the appropriateness and the like of the obtained clustering result. It has thus been difficult to evaluate whether or not the obtained clustering result is appropriate for the characteristics of the multidimensional data measured by the flow cytometer.

Therefore, there has been a demand for a technology capable of evaluating the appropriateness of the clustering result in consideration of characteristics of multidimensional data to be clustered.

### Solution to Problem

According to the present disclosure, there is provided an information processing apparatus comprising: at least one hardware processor; and at least one non-transitory computer-readable storage medium storing processor-executable instructions that, when executed by the at least one hardware processor, cause the at least one hardware processor to perform: receiving multidimensional data obtained from a plurality of cells; clustering the multidimensional data to generate clustering results indicating a plurality of clusters including a first cluster and a second cluster that share at least a portion of the multidimensional data; and outputting information representing reliability of the clustering results, wherein the information is indicative of a relationship between the first cluster and the second cluster.

Furthermore, according to the present disclosure, there is provided at least one non-transitory computer-readable storage medium storing processor-executable instructions that, when executed by at least one hardware processor, cause the at least one hardware processor to perform: receiving multidimensional data obtained from a plurality of cells; clustering the multidimensional data to generate clustering results indicating a plurality of clusters including a first cluster and a second cluster that share at least a portion of the multidimensional data; and outputting information representing reliability of the clustering results, wherein the information is indicative of a relationship between the first cluster and the second cluster.

Furthermore, according to the present disclosure, there is provided a method, comprising: receiving multidimensional data obtained from a plurality of cells;
clustering the multidimensional data to generate clustering results indicating a plurality of clusters including a first cluster and a second cluster that share at least a portion of the multidimensional data; and outputting information representing reliability of the clustering results, wherein the information is indicative of a relationship between the first cluster and the second cluster.

According to the present disclosure, by comparing the evaluation values of the respective clusters in the multistage clustering with each other, it is possible to determine whether or not there is a relationship between a pre-meta cluster and a post-meta cluster in a case where the clustering appropriateness is low.

### Advantageous Effects of Invention

As described above, according to the present disclosure, it is possible to evaluate the appropriateness of the clustering result in consideration of the characteristics of multidimensional data to be clustered.

Note that the above effects are not necessarily limited, and, along with or in place of the above effects, any of the effects illustrated in the present specification, or other effects that can be grasped from the present specification, may be exerted.

### BRIEF DESCRIPTION OF DRAWINGS

FIG. 1 is a schematic view schematically illustrating a configuration example of a system including an information processing apparatus according to an embodiment of the present disclosure.

FIG. 2 is a block diagram illustrating a configuration example of the information processing apparatus according to the embodiment.

FIG. 3A is an explanatory view illustrating an example of an image display that represents the result of clustering by the information processing apparatus.

FIG. 3B is an explanatory view illustrating an example of the image display that represents the result of clustering by the information processing apparatus.

FIG. 3C is an explanatory view illustrating an example of the image display that represents the result of clustering by the information processing apparatus.

FIG. 4 is a graph in which evaluation values of pre-meta clusters and a post-meta cluster are plotted for each post-meta cluster.

FIG. 5 is an explanatory view illustrating a mode in which measurement data for each dimension of selected clusters is additionally displayed from the graph in which evaluation values of the pre-meta clusters and the post-meta cluster are plotted for each post-meta cluster.

FIG. 6A is an explanatory view illustrating an example of an image display where an indication, which specifies a first cluster and a second cluster determined to have a predetermined relationship. is superimposed on the image display illustrated in FIG. 3A.

FIG. 6B is an explanatory view illustrating an example of an image display where an indication, which specifies a first cluster and a second cluster determined to have the predetermined relationship. is superimposed on the image display illustrated in FIG. 3B.

FIG. 6C is an explanatory view illustrating an example of an image display where an indication, which specifies a first cluster and a second cluster determined to have the predetermined relationship. is superimposed on the image display illustrated in FIG. 3C.

FIG. 7 is a flowchart illustrating an operation example of the information processing apparatus according to the embodiment.

FIG. 8 is a block diagram schematically illustrating a configuration example of an information processing apparatus according to a modification of the embodiment.

FIG. 9 is a flowchart illustrating an operation example of an information processing apparatus according to the modification of the embodiment.

FIG. 10 is a flowchart in the case of applying the information processing apparatus according to the embodiment to analysis of a pathological image.

FIG. 11 is a flowchart illustrating the flow of the analysis flow to which the information processing apparatus according to the embodiment is applied.

FIG. 12 is a flowchart in the case of applying the information processing apparatus according to the embodiment to comparative analysis between a plurality of samples.

FIG. 13 is a block diagram illustrating a hardware configuration example of the information processing apparatus according to the embodiment.

### DESCRIPTION OF EMBODIMENTS

Hereinafter, preferred embodiments of the present disclosure will be described in detail with reference to the accompanying drawings. Note that in the present specification and the drawings. components having substantially the same functional configuration will be assigned the same reference numerals, and redundant description will be omitted.

Note that the description will be made in the following order.
1. Configuration example of whole system
2. Configuration example of information processing apparatus
3. Operation example of information processing apparatus
4. Modification
5. Application example
6. Hardware configuration example

### 1. Configuration Example of Whole System

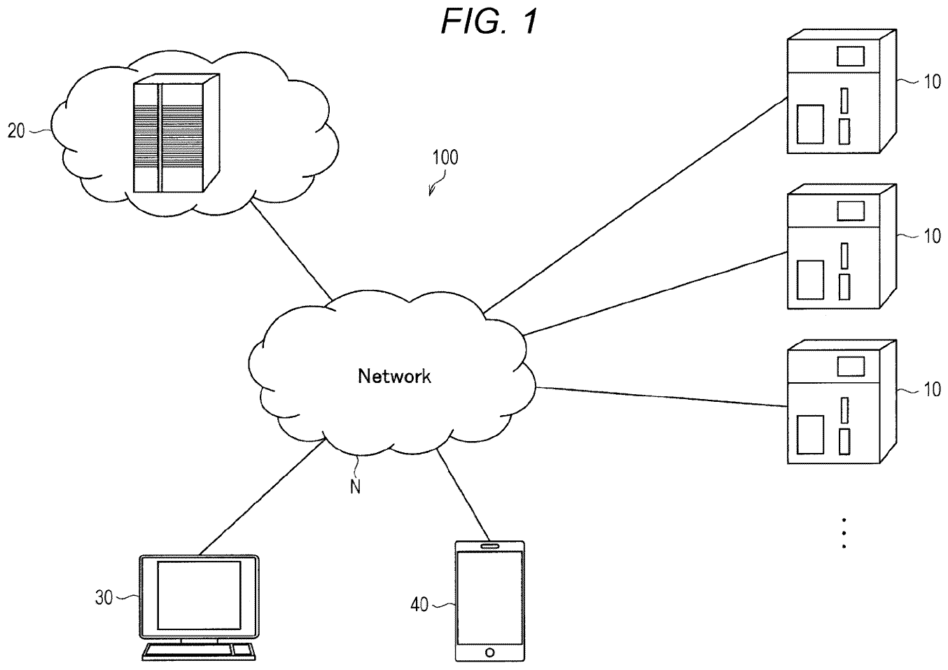

First, with reference to FIG. 1, a configuration of a system 100 including an information processing apparatus according to an embodiment of the present disclosure will be described. FIG. 1 is a schematic view schematically illustrating the configuration example of the system 100 including the information processing apparatus according to the present embodiment.

As illustrated in FIG. 1, a system 100 according to the present embodiment includes a measuring apparatus 10, an information processing apparatus 20, and terminal devices 30 and 40. The measuring apparatus 10. the information processing apparatus 20, and the terminal devices 30 and 40 are connected via a network N so as to be able to communicate with each other. The network N may, for example, be a mobile communication network or an information communication network, such as the Internet or a local area network, or may be a combination of a plurality of these networks.

The measuring apparatus 10 is a measuring apparatus capable of detecting fluorescence of each color from cells or the like to be measured. The measuring apparatus 10 may, for example, be a flow cytometer that allows fluorescently stained cells to flow at high speed through a flow cell and irradiates the flowing cells with light to detect fluorescence of each color light from the cells. Alternatively, the measuring apparatus may be a fluorescence microscope, a confocal laser microscope, or the like, that observes fluorescence of stained cells to detect fluorescence of each color light from the cells.

The information processing apparatus 20 clusters each of the cells to be measured on the basis of the information regarding the fluorescence of the cells measured by the measuring apparatus 10. Thereby, the information processing apparatus 20 can divide each of the cells measured by the measuring apparatus 10 into a plurality of groups (that is, clusters). Furthermore, the information processing apparatus 20 can evaluate the appropriateness of the result of clustering each of the cells. Thereby, the information processing apparatus 20 can transmit, to each of the terminal devices 30 and 40, information specifying a cluster with its clustering result determined not to be appropriate. The information processing apparatus 20 may, for example, be a server or the like that can process a large quantity of data at high speed.

Each of the terminal devices 30 and 40 is, for example, a display device or the like to which the result of clustering by the information processing apparatus 20 is output. For example, each of the terminal devices 30 and 40 may be a computer, a laptop, a smartphone, a tablet terminal, or the like provided with a display unit that displays the analysis result received from the information processing apparatus 20 as an image, characters, or the like.

In the system 100 including the information processing apparatus 20 according to the present embodiment, first, the information processing apparatus 20 acquires the measurement data measured by the measuring apparatus 10 provided in each of hospitals, clinics, or research institutes via the network N. Thereafter, the information processing apparatus 20 clusters the acquired measurement data and outputs the clustering result to each of the terminal devices 30 and 40. Moreover, in a case where there is a cluster determined to be low in appropriateness in the clustering result, the information processing apparatus 20 can output information specifying the cluster to each of the terminal devices 30 and 40. With the clustering having a high load of information processing, the efficiency of the entire system 100 can be improved by the intensive execution of the clustering by the information processing apparatus 20 configured by a dedicated server or the like.

A specific method for the clustering by the information processing apparatus 20 and a method for specifying a cluster determined to be low in appropriateness from the clustering result will be described in detail below.

Note that, although the measuring apparatus 10, the information processing apparatus 20, and the terminal devices 30 and 40 are mutually connected via the network N in the above, the technology according to the present disclosure is not limited to such an example. For example, the measuring apparatus 10, the information processing apparatus 20, and the terminal devices 30 and 40 may be connected directly.

### 2. Configuration Example of Information Processing Apparatus

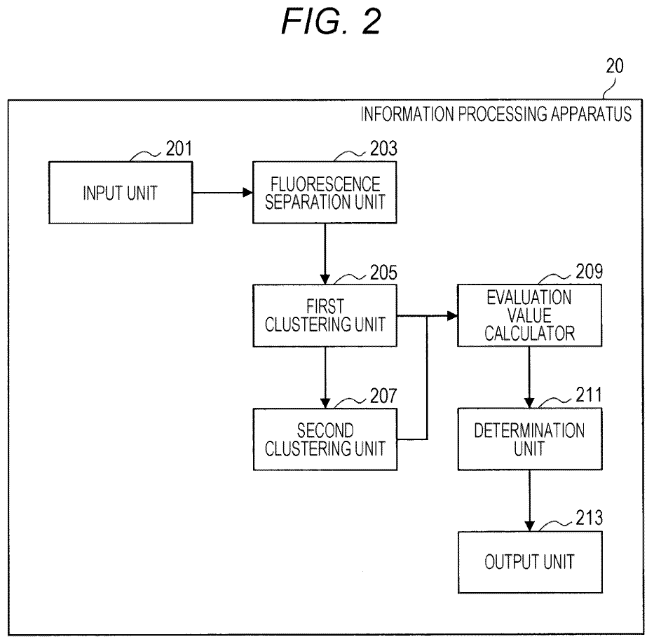

Next, a configuration example of the information processing apparatus 20 according to the present embodiment will be described with reference to FIG. 2. FIG. 2 is a block diagram illustrating the configuration example of the information processing apparatus 20 according to the present embodiment.

As illustrated in FIG. 2, the information processing apparatus 20 includes an input unit 201, a fluorescence separation unit 203, a first clustering unit 205, a second clustering unit 207, an evaluation value calculator 209, a determination unit 211, and an output unit 213. Note that some of the functions of the information processing apparatus 20 (for example, the function of the fluorescence separation unit 203 as described later) may be included in the measuring apparatus 10.

The input unit 201 acquires the measurement result of samples such as cells from the measuring apparatus 10. Specifically, from the measuring apparatus 10, the input unit 201 acquires information regarding the spectrum of fluorescence, or the intensity of fluorescence for each wavelength band, measured from samples such as cells. The input unit 201 may be configured by, for example, a connection port for acquiring information from the measuring apparatus 10 via the network N, or an external input interface including a communication device or the like.

The fluorescence separation unit 203 separates each fluorescence from the information regarding the spectrum of the fluorescence, or the intensity of the fluorescence for each wavelength band, acquired from the measuring apparatus 10 to derive an expression level of a fluorescent substance, a biomolecule, or the like corresponding to each fluorescence. The cells to be measured or the like are labeled with a plurality of fluorescent substances, and the wavelength distributions of fluorescence emitted from each fluorescent substance overlap each other. Therefore, the fluorescence separation unit 203 can derive the expression level of each fluorescent substance and the expression level of a biomolecule or the like labeled with each fluorescent substance by correcting mutual leakage of the fluorescence emitted from each fluorescent substance, and the like.

Accordingly, the fluorescence separation unit 203 can correct mutual leakage of each fluorescence and derive a net expression level of the fluorescent substance, thereby enabling the first clustering unit 205 in the latter stage to perform clustering with high accuracy. Here, the clustering with high accuracy is to be able to divide a large number of samples labeled with each fluorescent substance into a plurality of optimal sample groups. Furthermore, the fluorescence separation unit 203 derives the expression level of the fluorescent substance emitting each fluorescence from the information regarding the spectrum of the fluorescence or the intensity of fluorescence for each wavelength band, and can thus reduce the number of dimensions of the data to be used at the time of clustering in the first clustering unit 205 in the latter stage.

Specifically, in a case where the measurement result is the intensity of the fluorescence detected by division for each specific wavelength bands, the fluorescence separation unit 203 first calculates the leakage quantity of the fluorescence between each wavelength band. Next, the fluorescence separation unit 203 subtracts the calculated leakage quantity of the fluorescence from the intensity of the fluorescence for each wavelength band and can thereby derive the expression level of the fluorescent substance emitting the fluorescence. Accordingly, the fluorescence separation unit 203 enables the first clustering unit 205 in the latter stage to perform clustering with high accuracy.

Furthermore, in a case where the measurement result is a fluorescence spectrum obtained by the detector array detecting the fluorescence subjected to prism spectral separation, the fluorescence separation unit 203 first acquires a reference spectrum of the fluorescence of each fluorescent substance to be detected. Next, the fluorescence separation unit 203 estimates the superimposition of the fluorescence reference spectrum of each fluorescent substance from the detected fluorescence spectrum and can thus derive the expression level of each fluorescent substance. Accordingly, since the fluorescence separation unit 203 can derive the expression level of each fluorescent substance from the measurement result represented by the spectrum, thereby reducing the number of dimensions of the measurement data.

The first clustering unit 205 clusters the cells to be measured on the basis of the measurement data. Specifically, the first clustering unit 205 clusters the cells to be measured on the basis of the expression level of each fluorescent substance of the cells derived by the fluorescence separation unit 203. Thereby, the first clustering unit 205 divides a group of the cells to be measured into each of first clusters.

The cells to be measured are labeled with a plurality of fluorescent substances, and the expression levels of the plurality of fluorescent substances (that is, the expression levels of biomolecules labeled with fluorescent substances) differ from cell to cell. Therefore, in a case where the cells to be measured are divided, multidimensional data of the expression levels of a plurality of fluorescent substances is used. Such division using multidimensional data can be performed more quickly than manual division by using the clustering technology based on machine learning.

The clustering method used in the first clustering unit 205 is not particularly limited but may be a known clustering method. For example, the first clustering unit 205 may use a general clustering method such as a ward method, a group average method, a single link method, or a k-means method, or may use a self-organization map method.

The second clustering unit 207 further clusters the result of the clustering by the first clustering unit 205. Specifically, the second clustering unit 207 integrates or divides the first cluster generated as a result of the clustering by the first clustering unit 205 to generate a second cluster.

For example, the second clustering unit 207 may integrate the first clusters by using the known clustering method described above to generate a second cluster. Alternatively, the second clustering unit 207 may divide the first cluster by using the known clustering method described above to generate the second clusters.

Here, an upper cluster generated by integrating a plurality of clusters is referred to as a post-meta cluster (also referred to as meta cluster), and a plurality of lower clusters included in the upper cluster are referred to as pre-meta cluster (also referred to as som cluster). In other words, in a case where the second clustering unit 207 integrates the first clusters to generate the second cluster, the first cluster becomes the pre-meta cluster and the second cluster becomes the post-meta cluster. Furthermore, in a case where the second clustering unit 207 divides the first cluster to generate the second clusters, the first cluster becomes a post-meta cluster and the second cluster becomes a pre-meta cluster.

The results of the clustering by the first clustering unit 205 and the second clustering unit 207 may be output from the output unit 213 to each of the terminal devices 30, 40, and the like. For example, the clustering results output to each of the terminal devices 30, 40 or the like may be displayed as an image display on each of the terminal devices 30, 40, and the like.

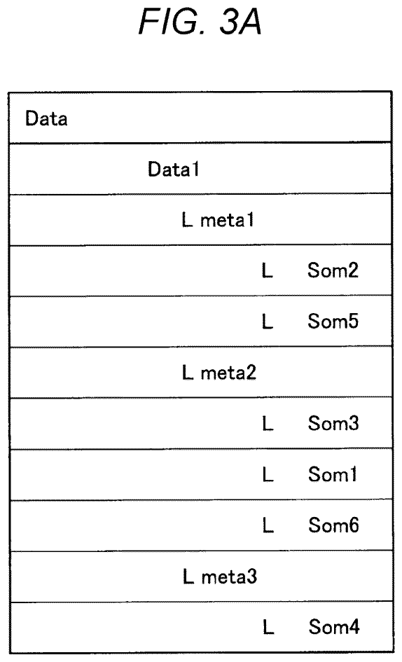

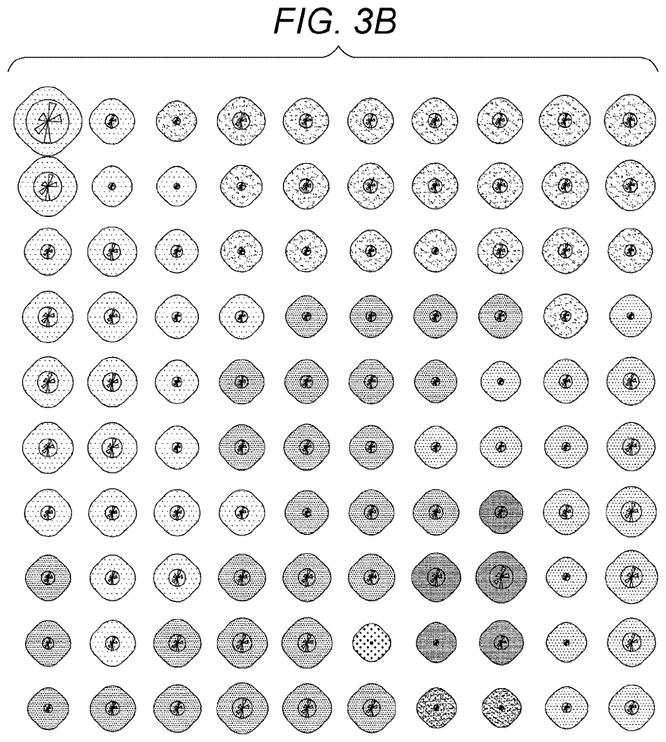

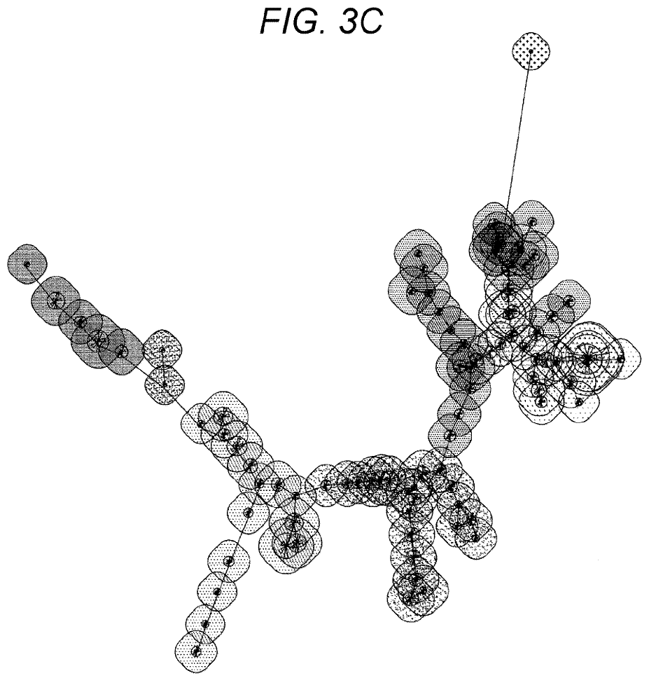

Specifically, the results of the clustering by the first clustering unit 205 and the second clustering unit 207 may be displayed in an image display illustrated in each of FIGS. 3A to 3C. FIGS. 3A to 3C are explanatory views illustrating an example of an image display that represents the result of clustering by the information processing apparatus 20.

For example, as illustrated in FIG. 3A. the results of the clustering by the first clustering unit 205 and the second clustering unit 207 may be represented in a tree display.

In the display illustrated in FIG. 3A, a sample “Data1” is clustered into post-meta clusters of “meta1” to “meta3” and pre-meta clusters of “Som1” to “Som6.” Furthermore, FIG. 3A clearly illustrates a structure in which the post-meta clusters of “meta1” to “meta3” include the pre-meta clusters of “Som1” to “Som6.” Specifically, the post-meta cluster of “meta1” includes the pre-meta clusters of “Som2” and “Som5”, the post-meta cluster of “meta2” includes the pre-meta clusters of “Som1”, “Som3” and “Som6”, and the post-meta cluster of “meta1” includes the pre-meta cluster of “Som4.” Such a tree display can clearly illustrate the hierarchical relationship between the pre-meta cluster and the post-meta cluster.

For example, as illustrated in FIG. 3B, the results of the clustering by the first clustering unit 205 and the second clustering unit 207 may be represented in a grid display.

In the display illustrated in FIG. 3B, radar charts painted in a plurality of colors are arranged in a grid. Here, each radar chart represents each of the pre-meta clusters, and a region colored with each color represents each of the post-meta clusters. Furthermore, the distribution of each radar chart represents a representative vector corresponding to the expression level of each fluorescent substance in the pre-meta cluster, and the size of each radar chart represents the size of a group of the pre-meta cluster. For example, radar charts (that is, pre-meta clusters) painted with the same color (same hatching in FIG. 3B) are included in the same post-meta cluster. Such a grid display can simultaneously illustrate the inclusion relationship between the pre-meta clusters and the post-meta cluster and information of the pre-meta clusters such as representative vectors.

For example, as illustrated in FIG. 3C, the results of the clustering by the first clustering unit 205 and the second clustering unit 207 may be represented in a minimum spanning tree display.

In the display illustrated in FIG. 3C, radar charts painted in a plurality of colors are arranged in a tree shape connected to each other. Here, each radar chart represents each of the pre-meta clusters, and a region colored with each color represents each of the post-meta clusters. Furthermore, the distribution of each radar chart represents a representative vector corresponding to the expression level of each fluorescent substance in the pre-meta cluster, and the size of each radar chart represents the size of a group of the pre-meta cluster. For example, radar charts (that is, pre-meta clusters) painted with the same color (same hatching in FIG. 3C) are included in the same post-meta cluster.

Moreover, in the display illustrated in FIG. 3C. the distance between the radar charts on the display corresponds to the similarity between the pre-meta clusters represented by the radar charts. In other words, it is shown that the pre-meta clusters of the radar charts that are close to each other are similar to each other, and the pre-meta clusters of the radar charts that are separate from each other are not similar to each other. Such a minimum spanning tree display can simultaneously illustrate the similarity relationship between the pre-meta clusters in addition to the inclusion relationship between the pre-meta clusters and the post-meta cluster.

The evaluation value calculator 209 calculates the evaluation value of each of the first cluster and the second cluster. The evaluation value of the cluster represents the separation degree of the cluster and is a value calculated from the distribution of clustered data. Specifically, the evaluation value of a cluster can be calculated on the basis of the dispersion of elements (e.g., detection events) belonging to the cluster and the distance between the cluster and another cluster. More specifically, the evaluation value of a cluster can be calculated on the basis of the distance between the element belonging to the cluster and the center of the cluster and the distance between the center of the cluster and the center of another cluster. For example, the evaluation value of each cluster may be a silhouette coefficient, DBindex, COP coefficient, or the like, of each cluster.

Note that the distance described above represents the similarity of each element. For example, the distance may be set on the basis of the property difference of each element so as to satisfy the axioms of distance. Specifically, the distance may be a Euclidean distance, Manhattan distance, Minkowski distance, Mahalanobis distance, or cosine distance between feature quantity vectors representing each element on the basis of its property.

The determination unit 211 determines whether or not the evaluation value of the first cluster and the evaluation value of the second cluster have a predetermined relationship. Specifically, the determination unit 211 determines whether or not the evaluation value of the first cluster and the evaluation value of the second cluster obtained by integrating or dividing the first cluster have a predetermined relationship. The predetermined relationship is a relationship that occurs between the evaluation values of the first cluster and the second cluster in a case where either the first cluster or the second cluster is low in clustering appropriateness. By determining the presence or absence of such a predetermined relationship, the determination unit 211 can specify the first cluster or the second cluster with low clustering appropriateness.

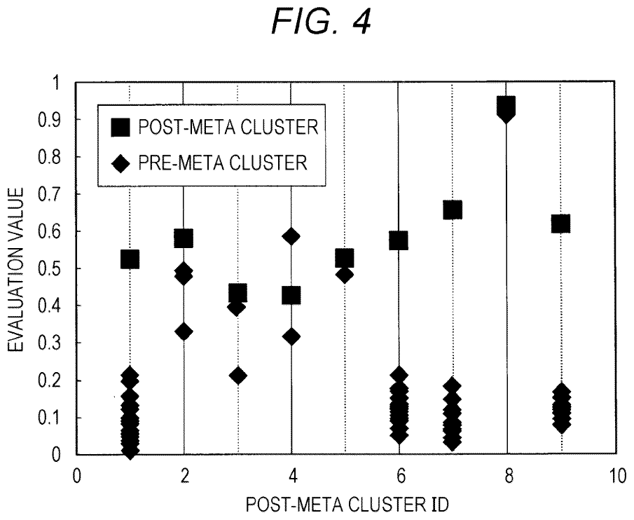

Here, an example of the predetermined relationship described above will be described with reference to FIG. 4. FIG. 4 is a graph in which the evaluation values of the pre-meta clusters and the post-meta cluster are plotted for each post-meta cluster. Note that the evaluation value shown on the vertical axis of FIG. 4 is, for example, the DBindex described above, indicating that the closer the numerical value is to 0, the higher the separation degree of clustering and the higher the clustering appropriateness.

As illustrated in FIG. 4, the determination unit 211 compares the evaluation values of the first cluster and the second cluster between the post-meta cluster and the pre-meta cluster included in the post-meta cluster. At this time, as in a post-meta cluster number 4, in a case where the evaluation value of the post-meta cluster is smaller (better) than the evaluation value of at least one or more pre-meta clusters, the determination unit 211 may determine that the pre-meta cluster and the post-meta cluster have the predetermined relationship. In a case where the integration makes the evaluation value of the post-meta cluster better than the evaluation value of the pre-meta cluster, the determination unit 211 can determine that clustering that is not appropriate has been performed either before or after the integration.

Alternatively, in a case where the closeness or discreteness degree of the evaluation values of the pre-meta clusters included in the post-meta cluster is equal to or higher than a threshold, the determination unit 211 may determine that the pre-meta cluster and the post-meta cluster have the predetermined relationship. Moreover, on the basis of the magnitude of the difference between the evaluation value of the pre-meta cluster and the evaluation value of the post-meta cluster, the determination unit 211 may determine whether or not the pre-meta cluster and the post-meta cluster have the predetermined relationship.

Note that the predetermined relationship may be another relationship other than those described above. The predetermined relationship may be a relationship registered in advance in a case where the clustering appropriateness in the first cluster and the second cluster is low.

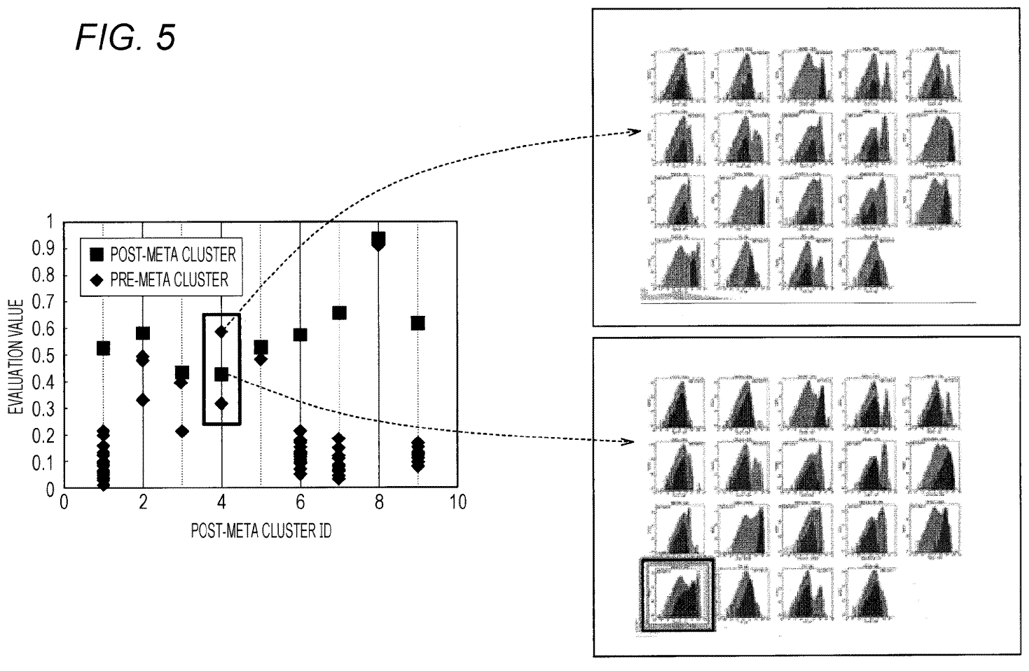

Furthermore, on the basis of an input from the user, the determination unit 211 may determine whether or not the evaluation value of the first cluster and the evaluation value of the second cluster have the predetermined relationship. Specifically, as illustrated in FIG. 5, the determination unit 211 may indicate to the user the graph in which the evaluation values of the pre-meta clusters and the post-meta cluster are plotted for each post-meta cluster and measurement data for each dimension of the clusters so that the user may select a first cluster and a second cluster having the predetermined relationship. FIG. 5 is an explanatory view illustrating an aspect of additionally displaying measurement data for each dimension of selected clusters from the graph in which the evaluation values of the pre-meta clusters and the post-meta cluster are plotted for each post-meta cluster.

As illustrated in FIG. 5, the determination unit 211 may present the user with a graph in which the evaluation values of the pre-meta clusters and the post-meta cluster are plotted for each post-meta cluster via the output unit 213. By investigating the presented graph, the user may specify clusters having the predetermined relationship between the evaluation value of the pre-meta cluster and the evaluation value of the post-meta cluster.

Furthermore, in the graph in which the evaluation values of the pre-meta clusters and the post-meta clusters are plotted, measurement data can be additionally displayed for each dimension of the selected clusters. The measurement data additionally displayed may, for example, be data indicating the distribution of the measurement target of the cluster with respect to the distribution of the entire measurement target for each dimension. Accordingly, the user may refer to the additionally displayed measurement data and determine the similarity between the distribution of the measurement target of the pre-meta cluster and the distribution of the measurement target of the post-meta cluster, to thereby determine whether or not the clustering of the pre-meta cluster and the clustering of the post-meta cluster are appropriate.

For example, in the case illustrated in FIG. 5, the distribution of the measurement target in a graph at the lower-left corner has significantly changed between the pre-meta cluster and the post-meta cluster. In a case as above where the distribution of the measured object in at least one or more dimensions significantly changes before and after the integration, either the pre-meta cluster or the post-meta cluster may be low in clustering appropriateness. Therefore, by investigating the measurement data for each dimension of the clusters, the user can specify a cluster with low clustering appropriateness in which the evaluation value of the first cluster and the evaluation value of the second cluster have the predetermined relationship.

Moreover. the determination unit 211 may highlight the graph in which the distribution of the measurement target has significantly changed between the pre-meta cluster and the post-meta cluster, in order to assist the user in specifying a cluster with low clustering appropriateness. Specifically, the determination unit 211 may change the color of the region displaying the graph in which the distribution of the measurement target has significantly changed between the pre-meta cluster and the post-meta cluster, may enclose with a frame line the region or may add a display illustrating an alert. Note that the graph in which the distribution of the measurement target has significantly changed between the pre-meta cluster and the post-meta cluster can be specified by, for example, determining whether or not each peak width. peak height, or peak position in the distribution of the measurement target has changed by a threshold or more before and after the integration.

The output unit 213 outputs information, which specifies the first cluster and the second cluster determined by the determination unit 211 to have the predetermined relationship, to each of the terminal devices 30, 40, and the like. Specifically, the output unit 213 may output, to each of the terminal devices 30 and 40, information for superimposing an image display specifying the first cluster and the second cluster determined by the determination unit 211 on an image display indicating the results of clustering by the first clustering unit 205 and the second clustering unit 207.

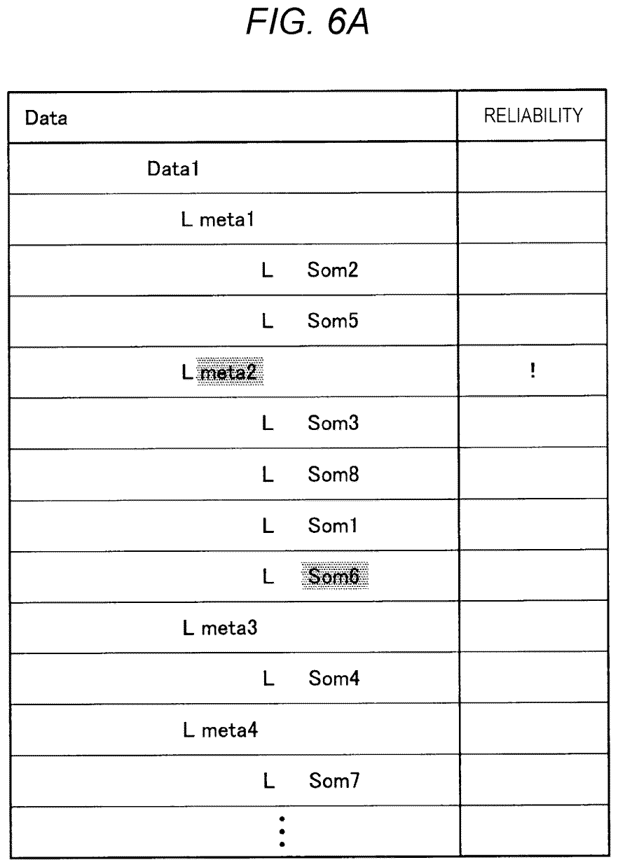

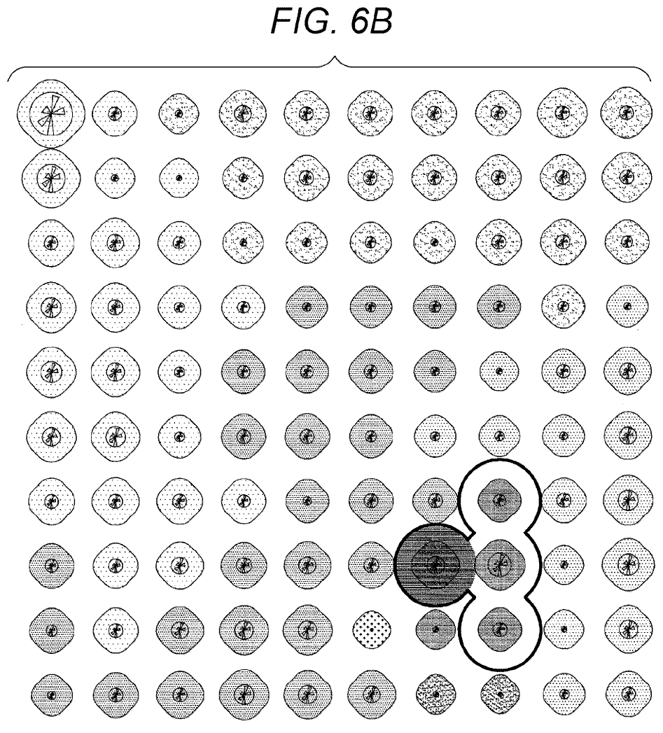

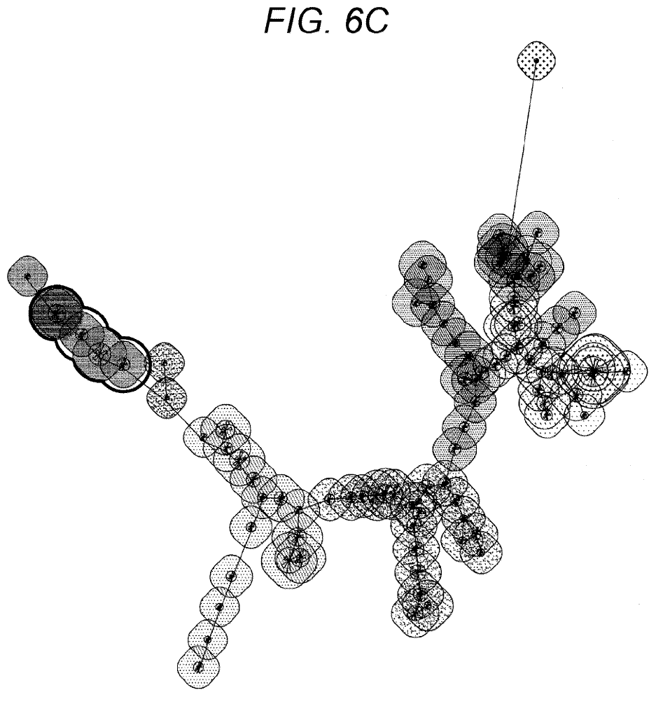

More specifically, for specifying the first cluster and the second cluster determined by the determination unit 211 to have the predetermined relationship, the output unit 213 may output information regarding an image display illustrated in each of FIGS. 6A to 6C to each of the terminal devices 30 and 40. By displaying the image display illustrated in each of FIGS. 6A to 6C, the terminal devices 30 and 40 can clearly indicate to the user the first cluster and the second cluster determined to have the predetermined relationship. FIGS. 6A to 6C are explanatory views each illustrating an example of an image display in which a display specifying the first cluster and the second cluster determined to have the predetermined relationship is superimposed on the image display illustrated in FIGS. 3A to 3C.

For example, as illustrated in FIG. 6A, in a case where the clustering result is displayed in a tree display the output unit 213 may change the display color or the display character of each of the first cluster and the second cluster determined to have the predetermined relationship. Alternatively, the output unit 213 may display a specific mark such as an exclamation mark on each of the first cluster and the second cluster determined to have the predetermined relationship. Specifically, in the case that the post-meta cluster of “meta2” and the pre-meta cluster of “Som6” are determined to have the predetermined relationship, the post-meta cluster of “meta2” are displayed with the exclamation mark and “meta2” and “Som6” are highlighted. Accordingly, the output unit 213 can draw the user's attention by clearly indicating to the user the first cluster and the second cluster that are low in clustering appropriateness and have the predetermined relationship.

For example, as illustrated in FIG. 6B, in a case where the clustering result is displayed in a grid display, the output unit 213 may enclose with a frame line a radar chart corresponding to the first cluster and the second cluster determined to have the predetermined relationship. Specifically, in the case that post-meta cluster including four pre-meta clusters and pre-meta cluster included in the post-meta cluster are determined to have the predetermined relationship, a region colored with a color representing the post-meta cluster is enclosed with a frame line and a radar chart corresponding to the pre-meta cluster are highlighted. Accordingly, the output unit 213 can draw the user's attention by clearly indicating to the user the first cluster and the second cluster that are low in clustering appropriateness and have the predetermined relationship.

For example, as illustrated in FIG. 6C, in a case where the clustering result is displayed in a spanning minimum tree display, the output unit 213 may enclose with a frame line a radar chart corresponding to the first cluster and the second cluster determined to have the predetermined relationship. Specifically, in the case that post-meta cluster including four pre-meta clusters and pre-meta cluster included in the post-meta cluster are determined to have the predetermined relationship, a region colored with a color representing the post-meta cluster is enclosed with a frame line and a radar chart corresponding to the pre-meta cluster are highlighted. Accordingly, the output unit 213 can draw the user's attention by clearly indicating to the user the first cluster and the second cluster that are low in clustering appropriateness and have the predetermined relationship.

According to the above configuration. the information processing apparatus 20 can evaluate the appropriateness of the clustering by the first clustering unit 205 and the second clustering unit 207 and present the user with the first cluster and the second cluster determined to be low in appropriateness. Accordingly, the user can determine a cluster to be reviewed for clustering or a cluster with high accuracy of clustering. Therefore, the information processing apparatus 20 can improve efficiency in analyzing the measurement target.

Note that the generation of the second cluster by the division or integration of the first cluster by the second clustering unit 207 may be executed on the basis of an input from the user. In other words, in the information processing apparatus 20, the second cluster may be generated by the user editing the first cluster generated by the clustering by the first clustering unit 205. At this time, the information processing apparatus 20 may evaluate the appropriateness of the clustering by the user by a similar configuration to the configuration described above.

### 3. Operation Example of Information Processing Apparatus

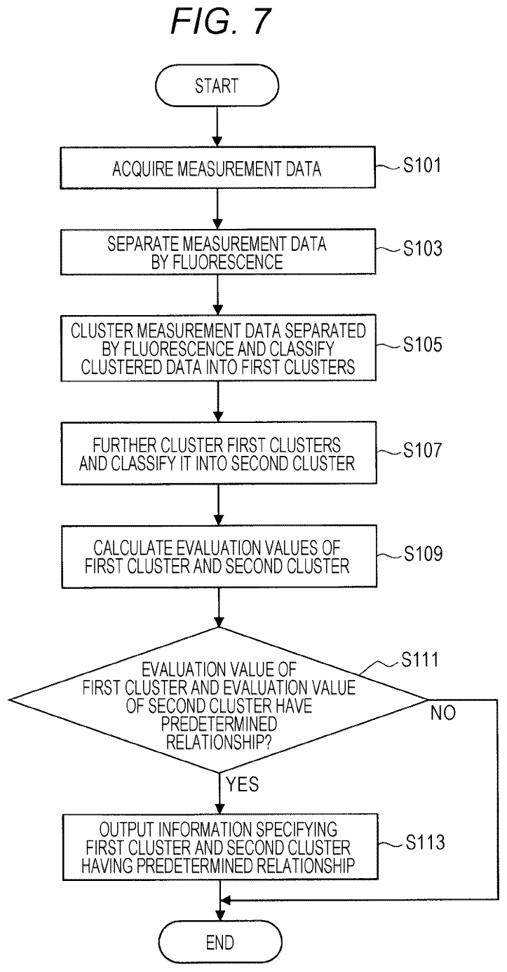

Next, with reference to FIG. 7, an operation example of the information processing apparatus 20 according to the present embodiment will be described. FIG. 7 is a flowchart illustrating an operation example of the information processing apparatus 20 according to the present embodiment.

As illustrated in FIG. 7, first, the input unit 201 acquires measurement data from the measuring apparatus 10 (S101). The measurement data may, for example, be information regarding the spectrum of fluorescence of cells measured by the flow cytometer or the intensity of the fluorescence for each wavelength band. Next, the fluorescence separation unit 203 separates the measurement data by fluorescence to derive an expression level of a fluorescent substance that emits each of fluorescence (S103).

Subsequently, the first clustering unit 205 clusters each of the measured cells on the basis of the expression level of each fluorescent substance separated by fluorescence by the fluorescence separation unit 203, to generate a first cluster (S105). Next, the second clustering unit 207 further integrates or divides the first cluster generated by the first clustering unit by the clustering, to generate a second cluster (S107). Thereafter, the evaluation value calculator 209 calculates the evaluation values of the first cluster and the second cluster (S109). For example, the evaluation value calculator 209 may calculate the silhouette coefficient, DBindex, or COP coefficient of each of the first cluster and the second cluster.

Next, the determination unit 211 determines whether or not the evaluation value of the first cluster and the evaluation value of the second cluster have a predetermined relationship (S111). Specifically, by determining whether or not the evaluation value of the first cluster and the evaluation value of the second cluster have the predetermined relationship. the determination unit 211 specifies the first cluster and the second cluster that are low in clustering appropriateness. In a case where the first cluster and the second cluster having the predetermined relationship do not exist (S111/No), the output unit 213 outputs the results of the clustering by the first clustering unit 205 and the second clustering unit 207 to each of the terminal devices 30 and 40. Thereby, the clustering results are presented to the user. The output unit 213 can present the clustering results to the user.

On the other hand, in a case where the first cluster and the second cluster having the predetermined relationship exist (S111/Yes), the output unit 213 outputs the results of the clustering by the first clustering unit 205 and the second clustering unit 207 and information specifying the first cluster and the second cluster which have the predetermined relationship to each of the terminal devices 30 and 40 (S113). Thereby, the output unit 213 can present the user with the first cluster and the second cluster determined to be low in clustering appropriateness.

According to the above operation, the information processing apparatus 20 according to the present embodiment can present the user with the clustering results and the information regarding the reliability of the clustering results. Specifically, the information processing apparatus 20 can specify a cluster determined to be low in clustering appropriateness and present the specified cluster to the user.

### 4. Modification

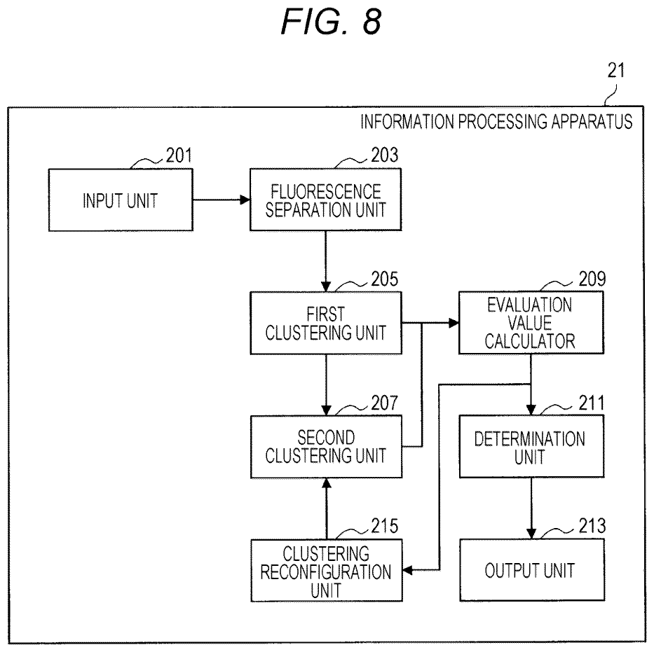

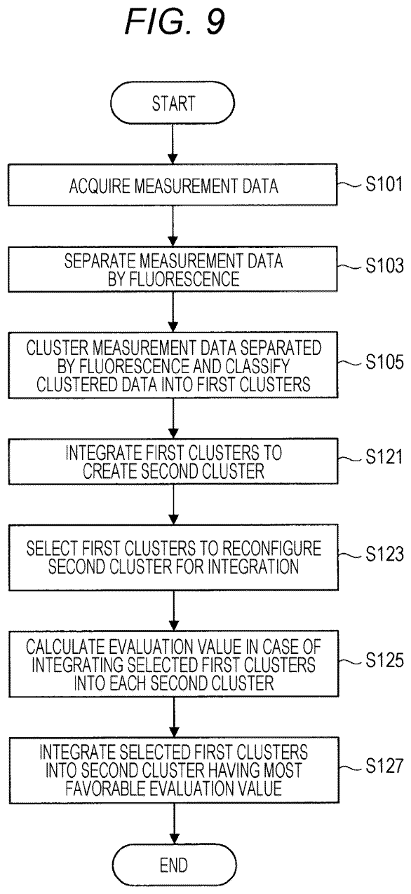

Subsequently, a modification of an information processing apparatus 21 according to the present embodiment will be described with reference to FIGS. 8 and 9. FIG. 8 is a block diagram schematically illustrating a configuration example of the information processing apparatus 21 according to the present modification, and FIG. 9 is a flowchart illustrating an operation example of the information processing apparatus 21 according to the present modification.

As illustrated in FIG. 8, the information processing apparatus 21 according to the present modification differs from the information processing apparatus 20 illustrated in FIG. 2 in further including a clustering reconfiguration unit 215. In the following, the clustering reconfiguration unit 215 which is characteristic of the present modification will be described, and the description of the other configurations substantially similar to those of the information processing apparatus 20 illustrated in FIG. 2 will be omitted.

The clustering reconfiguration unit 215 reconfigures a post-meta cluster including pre-meta clusters on the basis of the evaluation values of the clusters. Specifically, the clustering reconfiguration unit 215 refers to the evaluation values of the clusters to reconsider the post-meta cluster that includes the instructed pre-meta clusters.

For example, the user who has referred to the clustering result and determined that the inclusion of some of the pre-meta clusters with respect to the post-meta cluster are not appropriate instructs the clustering reconfiguration unit 215 to reconfigure the post-meta cluster that includes the pre-meta clusters. At this time, the clustering reconfiguration unit 215 causes the determination unit 211 to comprehensively calculate the evaluation values of all clusters in the case of integrating the pre-meta clusters instructed by the user into each of the post-meta clusters. Subsequently, the clustering reconfiguration unit 215 specifies a post-meta cluster in which the evaluation value of the clusters is best due to the integration of the instructed pre-meta cluster. The clustering reconfiguration unit 215 then integrates the instructed pre-meta clusters into the post-meta cluster. Note that that the evaluation value of the cluster is best means that, for example, in DBindex, the sum of all the evaluation values of the post-meta cluster is the smallest.

Accordingly, the information processing apparatus 21 can support the user to edit the clustering of the pre-meta cluster and the post-meta cluster and can present a more appropriate clustering result. Note that the selection of the pre-meta cluster by the user may be performed from the image display representing the clustering result and the determination result of the appropriateness as illustrated in FIGS. 3A to 3C or FIGS. 6A to 6C. The selection of the pre-meta cluster by the user may be performed from an image display representing a graph in which the evaluation values of the pre-meta cluster and the post-meta cluster are plotted as illustrated in FIG. 4 or 5.

Next, with reference to FIG. 9, an operation example of the information processing apparatus 21 according to the present modification will be described. FIG. 9 is a flowchart illustrating an operation example of the information processing apparatus 21 according to the present modification.

As illustrated in FIG. 9, first, the input unit 201 acquires measurement data from the measuring apparatus 10 (S101). The measurement data may. for example, be information regarding the spectrum of fluorescence of cells measured by the flow cytometer or the intensity of the fluorescence for each wavelength band. Next, the fluorescence separation unit 203 separates the measurement data by fluorescence to derive an expression level of a fluorescent substance that emits each of fluorescence (S103).

Subsequently, the first clustering unit 205 clusters each of the measured cells on the basis of the expression level of each fluorescent substance separated by fluorescence by the fluorescence separation unit 203, to generate a first cluster (S105). Next, the second clustering unit 207 further integrates the first clusters generated by the first clustering unit 205 by clustering to generate a second cluster (S121).

Thereafter, the first cluster for reconfiguring the second cluster for the inclusion is selected by the user or the like (S123). Subsequently, the determination unit 211 calculates the evaluation value of each cluster in the case of integrating the selected first clusters into each of the second clusters (S125). Next, the clustering reconfiguration unit 215 compares the total of the calculated evaluation values of the respective clusters for each second cluster and integrates the selected first clusters into the second cluster in which the total of the evaluation values is best (S127).

According to the above operation, the information processing apparatus 21 according to the present modification can support the integration of the first clusters selected by the user into the more appropriate second cluster.

### 5. Application Example

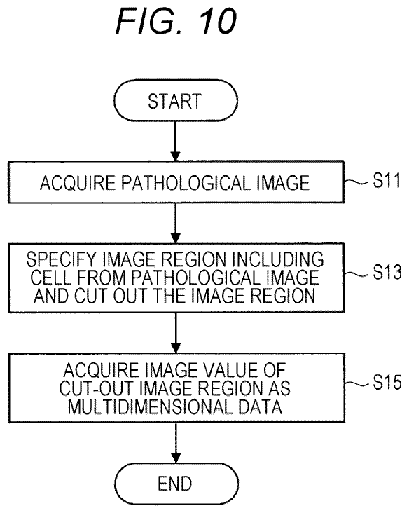

Subsequently, application examples of the information processing apparatus 20 according to the present embodiment will be described with reference to FIGS. 10 to 12.

First, with reference to FIG. 10. an example in which the information processing apparatus 20 according to the present embodiment is applied to analysis of a pathological image will be described. FIG. 10 is a flowchart in the case of applying the information processing apparatus 20 according to the present embodiment to analysis of a pathological image.

As illustrated in FIG. 10, first, the information processing apparatus 20 acquires a pathological image including a cell from a microscope, an endoscope, or the like (S11). Next, the information processing apparatus 20 specifies an image region including the cell from the pathological image and cuts out the image region (S13). Specifically, if the pathological image is an image of a cell stained with a nucleus, the information processing apparatus 20 may recognize the stained nucleus by performing edge extraction and consider surrounding pixels of the recognized nucleus as the cell. Alternatively, the information processing apparatus 20 may recognize the cell from the pathological image by using deep learning or the like.

Thereafter, the information processing apparatus 20 acquires pixel values of the cut-out image region as multidimensional data indicating the feature quantities of the cell (S15). Specifically, the pixel value may be a median value, an average value, or a mode value of an RGB (red, green, and blue) value of each pixel or may be an HSV (hue, saturation, and chroma) value derived by converting the coordinates of the color space from the RGB value of each pixel. Furthermore, as the feature quantities of the cell, the information processing apparatus 20 may acquire morphological features such as an area, roundness, width, length, width/length ratio, symmetry in the axial direction or the radial direction, or tightness. Moreover, as the feature quantities of the cell, the information processing apparatus 20 may acquire structural features such as spots, holes, edges, peaks, valleys, ridges, bright spots, or dark spots or may acquire so-called Haralick features or Gabor features, or the like.

Thereby, the information processing apparatus 20 can acquire the measurement data acquired by the input unit 201 described above. The subsequent operation example is as described above, and hence, the description thereof is omitted.

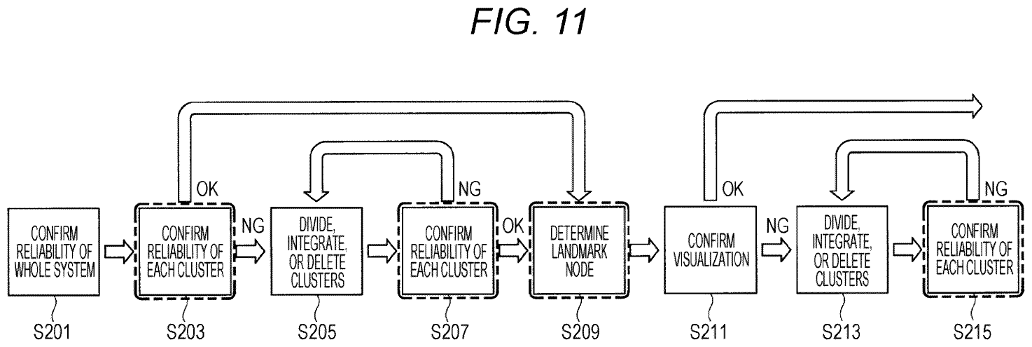

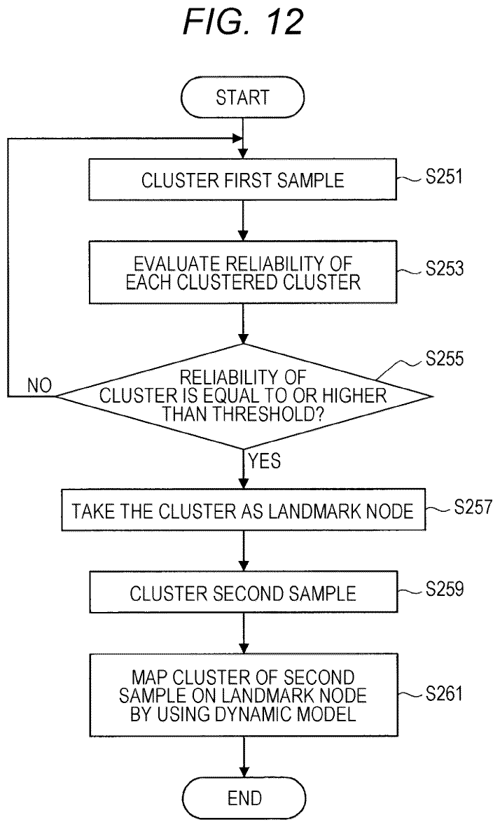

Next, an example in which the information processing apparatus 20 according to the present embodiment is used for analysis will be described with reference to FIGS. 11 and 12. FIG. 11 is a flowchart illustrating the flow of the analysis flow to which the information processing apparatus 20 according to the present embodiment is applied. FIG. 12 is a flowchart in the case of applying the information processing apparatus 20 according to the present embodiment to comparative analysis between a plurality of samples.

As illustrated in FIG. 11, in a case where the information processing apparatus 20 according to the present embodiment is applied to the analysis flow of a sample, it is first confirmed that there is no problem with the reliability of the entire system with respect to the measured sample (S201). The reliability can be evaluated based on the evaluation value calculated by the evaluation value calculator 209. Next, it is confirmed that the reliability of each clustered cluster is sufficiently high (S203). Here, in a case where the reliability of each clustered cluster is not sufficiently high (S203/No), division, integration, or deletion of clusters is performed again (S205), and thereafter, it is confirmed that the reliability of each cluster is sufficiently high (S207). Specifically, the appropriateness of the division, integration, or deletion of the clusters can be evaluated based on whether or not the post-meta cluster and the pre-meta cluster have predetermined relationship. The division, integration, or deletion of the clusters is repeated until the reliability of each clustered cluster becomes sufficiently high, and thereafter, a landmark node is set for the cluster with its reliability having become sufficiently high (S209).

The landmark node is, for example, a cluster that is a starting point of visualization in a visualization method such as a scaffold map, or a cluster that is a reference point in a case where comparing a plurality of samples. The cluster that serves as the landmark node needs to have high reliability.

After the setting of the cluster that serves as the landmark node, visualization confirmation of each cluster is performed using a scaffold map or the like (S211). In a case where obtaining the desired result in the visualization confirmation is not possible, the division, integration, or deletion of the clusters (S213) and the reliability confirmation of each cluster (S215) are performed again, and the cluster that serves as the landmark node is reconfigured so as to be able to obtain the desired result.

In the analysis flow as illustrated in FIG. 11, the information processing apparatus 20 according to the present embodiment may be applied to any of the processing of S203, S207, S209, and S215 for confirming the reliability of each cluster.

Furthermore, as illustrated in FIG. 12, in a case where the information processing apparatus 20 according to the present embodiment is applied to comparative analysis between a plurality of samples, first, the clustering of the first sample is performed (S251). Next, the reliability of each cluster clustered in the first sample is evaluated (S253). The reliability can be evaluated based on the evaluation value calculated by the evaluation value calculator 209. Subsequently, it is determined whether or not the reliability of each cluster is equal to or higher than a threshold (S255). In a case where the reliability of each cluster is lower than the threshold (S255/No), the clustering of the first sample and the evaluation of the reliability of each cluster are performed again. On the other hand, in a case where the degree of reliability of each cluster is equal to or higher than the threshold (S255/Yes), the cluster with the reliability equal to or higher than the threshold is set as a landmark node (S257).

Next, a second sample is clustered separately (S259). Here, with respect to the landmark node set in the first sample, each cluster clustered in the second sample is mapped using a mechanical model (S261). Thereby, the user can perceive the correspondence of each cluster of the first sample and the second sample and perform comparative analysis between the first sample and the second sample.

Note that as the mechanical model, for example, a Force-Direct graph, a Kamada-Kawai algorithm, a Fruchterman-Reingold algorithm, or the like can be used. Furthermore, as target data of the dynamic model, any one of a median, an average, and a mode of each landmark node may be used.

In the comparative analysis between a plurality of samples as illustrated in FIG. 12, the information processing apparatus 20 according to the present embodiment may be applied to either the processing of S253 or S257 in which the reliability of each cluster is evaluated.

### 6. Hardware Configuration Example

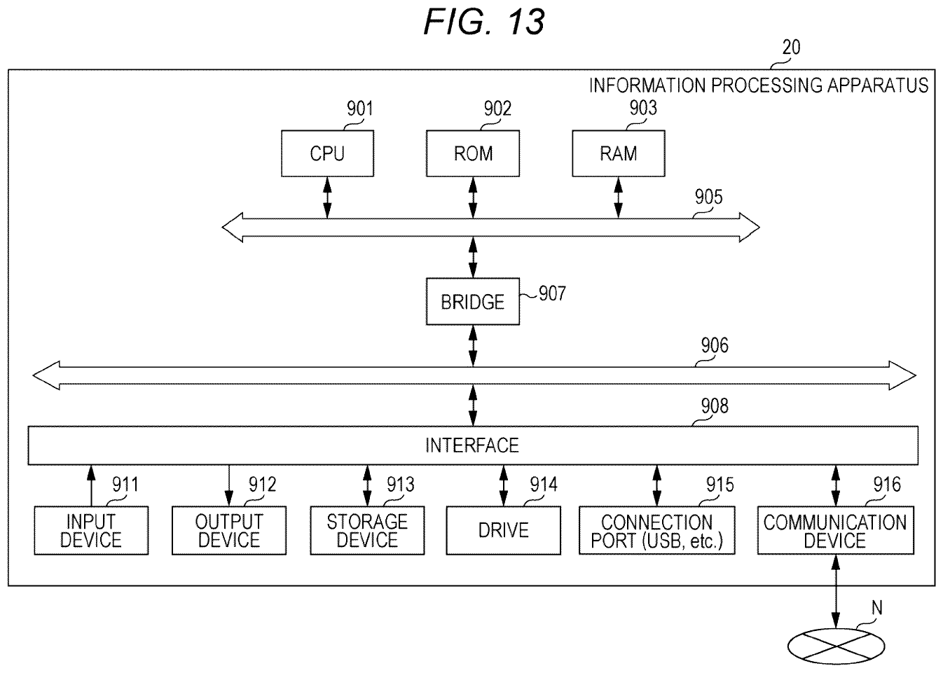

Subsequently, the hardware configuration of the information processing apparatus 20 according to the present embodiment will be described with reference to FIG. 13. FIG. 13 is a block diagram illustrating an example of the hardware configuration of the information processing apparatus 20 according to the present embodiment.

As illustrated in FIG. 13, the information processing apparatus 20 includes a central processing unit (CPU) 901, a read-only memory (ROM) 902, a random access memory (RAM) 903, a bridge 907, internal buses 905, 906, an interface 908, an input device 911, an output device 912, a storage device 913, a drive 914, a connection port 915, and a communication device 916.

The CPU 901 functions as an arithmetic processing unit and a control device, and controls the overall operation of the information processing apparatus 20 in accordance with various programs stored in the ROM 902 or the like. The ROM 902 stores programs to be used by the CPU 901 and calculation parameters, and the RAM 903 temporarily stores programs used in the execution of the CPU 901, parameters that appropriately change in the execution, and the like. For example, the CPU 901 may execute the functions of the fluorescence separation unit 203, the first clustering unit 205, the second clustering unit 207, the evaluation value calculator 209, and the determination unit 211.

The CPU 901, the ROM 902, and the RAM 903 are mutually connected through the bridge 907, the internal buses 905, 906, and the like. Furthermore, the CPU 901, the ROM 902, and the RAM 903 are also connected to the input device 911, the output device 912, the storage device 913, the drive 914, the connection port 915, and the communication device 916 through the interface 908.

The input device 911 includes an input device with which information is input, such as a touch panel, a keyboard, a mouse, a button, a microphone, a switch, and a lever. Furthermore, the input device 911 also includes an input control circuit and the like for generating an input signal on the basis of the input information and outputting the signal to the CPU 901. The input device 911 may perform the function of the input unit 201, for example.

The output device 912 includes, for example, display devices such as a cathode ray tube (CRT) display device, a liquid crystal display device, and an organic electro-luminescence (EL) display device. Moreover, the output device 912 may include audio output devices such as a speaker and headphones. The output device 912 may perform the function of the output unit 213, for example.

The storage device 913 is a storage device for storing the data of the information processing apparatus 20. The storage device 913 may include a storage medium, a storage device that stores data into the storage medium, a reading device that reads data from the storage medium, and a deletion device that deletes stored data.

The drive 914 is a read writer for the storage medium and is built in or externally attached to the information processing apparatus 20. For example, the drive 914 reads information stored in a removable storage medium mounted therein, such as a magnetic disk, optical disk, magneto-optical disk, or semiconductor memory, and outputs the read information to the RAM 903. The drive 914 can also write information into a removable storage medium.

The connection port 915 is, for example, a connection interface configured by a connection port for connecting an externally connected device such as a universal serial bus (USB) port, an Ethernet (registered trademark) port, an IEEE 802.11 standard port, and an optical audio terminal.

The communication device 916 is, for example, a communication interface configured by a communication device or the like for connecting to the network N. Furthermore, the communication device 916 may be a wired or wireless LAN compatible communication device or a cable communication device that performs wired cable communication. The communication device 916 and the connection port 915 may perform the functions of the input unit 201 and the output unit 213, for example.

Note that in addition, it is possible to create a computer program for causing the hardware that is built in the information processing apparatus 20, such as a CPU, a ROM, and a RAM to exhibit an equivalent function to the function of each configuration of the information processing apparatus according to the present embodiment described above. Furthermore, it is possible to provide a storage medium in which the computer program is stored.

The above-described embodiments may be implemented using hardware, software or a combination thereof. When implemented in software, the software code can be executed on any suitable processor (e.g., a microprocessor) or collection of processors, whether provided in a single computing device or distributed among multiple computing devices. It should be appreciated that any component or collection of components that perform the functions described above can be generically considered as one or more controllers that control the above-discussed functions. The one or more controllers can be implemented in numerous ways, such as with dedicated hardware, or with general purpose hardware (e.g., one or more processors) that is programmed using microcode or software to perform the functions recited above.

In this respect, it should be appreciated that one implementation of the embodiments described herein comprises at least one computer-readable storage medium (e.g., RAM, ROM, EEPROM, flash memory or other memory technology, CD-ROM, digital versatile disks (DVD) or other optical disk storage, magnetic cassettes, magnetic tape, magnetic disk storage or other magnetic storage devices, or other tangible, non-transitory computer-readable storage medium) encoded with a computer program (i.e., a plurality of executable instructions) that, when executed on one or more processors, performs the above-discussed functions of one or more embodiments. The computer-readable medium may be transportable such that the program stored thereon can be loaded onto any computing device to implement aspects of the techniques discussed herein. In addition, it should be appreciated that the reference to a computer program which, when executed, performs any of the above-discussed functions, is not limited to an application program running on a host computer. Rather, the terms computer program and software are used herein in a generic sense to reference any type of computer code (e.g., application software, firmware, microcode, or any other form of computer instruction) that can be employed to program one or more processors to implement aspects of the techniques discussed herein.

The preferred embodiments of the present disclosure have been described in detail with reference to the accompanying drawings, but the technical scope of the present disclosure is not limited to such examples. It is obvious that those skilled in the art of the present disclosure can conceive of various modifications or alterations within the scope of the technical idea described in the claims. It is understood that these also naturally fall within the technical scope of the present disclosure.

Furthermore, the effects described in the present specification are merely illustrative or exemplary, and not limiting. That is, the technology according to the present disclosure can exhibit other effects apparent to those skilled in the art from the description of the present specification, in addition to or instead of the effects described above.

Note that the following configurations are also within the technical scope of the present disclosure.

(1)

An information processing apparatus including:
an evaluation value calculator configured to calculate an evaluation value of each of first clusters that are a clustering result obtained by clustering multidimensional data, and an evaluation value of each of second clusters that are a clustering result obtained by further clustering the first clusters;
a determination unit configured to determine whether or not the evaluation value of the first cluster and the evaluation value of the second cluster obtained by clustering the first cluster have a predetermined relationship; and
an output unit configured to output information specifying the first cluster and the second cluster determined to have the predetermined relationship.
   (2)

The information processing apparatus according to (1) described above, in which the evaluation value is an index regarding a separation degree of each of clusters.

(3)

The information processing apparatus according to (2) described above, in which the evaluation value calculator calculates the evaluation value on the basis of a distance between clusters and a distance between each event in a cluster and a cluster center.

(4)

The information processing apparatus according to (3) described above, in which the distance is set on the basis of a property difference of each of elements of the multidimensional data.

(5)

The information processing apparatus according to any one of (1) to (4) described above, in which the second cluster is a cluster obtained by integrating the first clusters.

(6)

The information processing apparatus according to (5) described above, in which the determination unit determines whether or not the evaluation value of the first cluster and the evaluation value of the second cluster obtained by integrating the first clusters have the predetermined relationship.

(7)

The information processing apparatus according to (6) described above, in which in a case where the evaluation value of the second cluster after the integration is better than an evaluation value of at least one or more of the first clusters before the integration, the determination unit determines that the first cluster and the second cluster have the predetermined relationship.

(8)

The information processing apparatus according to any one of (5) to (7) described above, further including
a clustering reconfiguration unit configured to reconfigure the second cluster into which the selected first clusters are integrated,
in which the evaluation value calculator calculates an evaluation value of the second cluster in a case where the selected first clusters are integrated into each of a plurality of second clusters, and
the clustering reconfiguration unit reconfigures the second cluster into which the selected first clusters are integrated on the basis of the calculated evaluation value.
   (9)

The information processing apparatus according to any one of (1) to (4) described above, in which the second cluster is a cluster obtained by dividing the first cluster.

(10)

The information processing apparatus according to (9) described above, in which in a case where an evaluation value of the first cluster before the division is better than an evaluation value of at least one or more of the second clusters after the division, the determination unit determines that the first cluster and the second cluster have the predetermined relationship.

(11)

The information processing apparatus according to any one of (1) to (10) described above, further including:
a first clustering unit configured to derive the first cluster by clustering the multidimensional data; and
a second clustering unit configured to derive the second cluster by clustering the first cluster.
   (12)

The information processing apparatus according to (11) described above, in which the second clustering unit clusters the first cluster on the basis of an input from a user.

(13)

The information processing apparatus according to any one of (1) to (12) described above, in which the multidimensional data is data obtained by separating light sensed from a cell into a plurality of pieces of fluorescence.

(14)

An information processing method, including:
calculating, by a calculator. an evaluation value of each of first clusters that are a clustering result obtained by clustering multidimensional data, and an evaluation value of each of second clusters that are a clustering result obtained by further clustering the first clusters;
determining whether or not the evaluation value of the first cluster and the evaluation value of the second cluster obtained by clustering the first cluster have a predetermined relationship; and
outputting information specifying the first cluster and the second cluster determined to have the predetermined relationship.
   (15)

A program that causes a computer to function as
an evaluation value calculator configured to calculate an evaluation value of each of first clusters that are a clustering result obtained by clustering multidimensional data, and an evaluation value of each of second clusters that are a clustering result obtained by further clustering the first clusters,
a determination unit configured to determine whether or not the evaluation value of the first cluster and the evaluation value of the second cluster obtained by clustering the first cluster have a predetermined relationship, and
an output unit configured to output information specifying the first cluster and the second cluster determined to have the predetermined relationship.
   (16)

An information processing apparatus comprising:
at least one hardware processor; and
at least one non-transitory computer-readable storage medium storing processor-executable instructions that, when executed by the at least one hardware processor, cause the at least one hardware processor to perform:
receiving multidimensional data obtained from a plurality of cells;

clustering the multidimensional data to generate clustering results indicating a plurality of clusters including a first cluster and a second cluster that share at least a portion of the multidimensional data: and
outputting information representing reliability of the clustering results, wherein the information is indicative of a relationship between the first cluster and the second cluster.
   (17)

The information processing apparatus according to (16) described above, wherein the information representing reliability of the clustering results is obtained by determining a first evaluation value for the first cluster and a second evaluation value for the second cluster, and the information indicates a relationship between the first evaluation value and the second evaluation value.

(18)

The information processing apparatus according to (17) described above, wherein the first evaluation value is an index associated with a separation degree of the first cluster from at least some of the plurality of clusters.

(19)

The information processing apparatus according to (17) or (18) described above, wherein the first cluster corresponds to a set of detection events in the multidimensional data, and determining the first evaluation value further comprises determining a distance between individual detection events in the set and a center of the first cluster.

(20)

The information processing apparatus according to any one of (16) to (19) described above, wherein the second cluster is obtained by integrating the first cluster with another cluster of the plurality of clusters.

(21)

The information processing apparatus according to (20) described above, wherein the relationship between the first evaluation value and the second evaluation value is that the first evaluation value is greater than the second evaluation value.

(22)

The information processing apparatus according to any one of (16) to (19) described above, wherein the second cluster is obtained by dividing the first cluster into multiple clusters.

(23)

The information processing apparatus according to (22) described above, wherein the relationship between the first evaluation value and the second evaluation value is that the second evaluation value is greater than the first evaluation value.

(24)

The information processing apparatus according to any one of (16) to (19) described above, wherein clustering the multidimensional data further comprises:
clustering the multidimensional data to generate a first group of clusters including the first cluster corresponding to a set of detection events in the multidimensional data; and
clustering the set of detection events to generate a second group of clusters including the second cluster.
   (25)

The information processing apparatus according to (19) or (24) described above, wherein each in the set of detection events corresponds to measurement data obtained from one of the plurality of cells.

(26)

The information processing apparatus according to any one of (16) to (25) described above, wherein outputting the information further comprises displaying a graphic illustrating the relationship between the first cluster and the second cluster.

(27)

The information processing apparatus according to any one of (16) to (26) described above, wherein outputting the information further comprises displaying radar charts corresponding to clusters and a line enclosing radar charts corresponding to a group of clusters representing the first cluster. wherein the group of clusters includes the second cluster.

(28)

The information processing apparatus according to (27) described above, wherein outputting the information further comprises displaying a graphic where the radar charts are connected by lines, and wherein the radar charts corresponding to the group of clusters are connected to each other by at least some of the lines.

(29)

The information processing apparatus according to any one of (16) to (28) described above, wherein the multidimensional data is indicative of fluorescence intensity spectrum obtained using a plurality of excitation wavelengths.

(30)

The information processing apparatus according to (29) described above, wherein the multidimensional data includes a fluorescence intensity spectrum for each of the plurality of excitation wavelengths.

(31)

The information processing apparatus according to any one of (16) to (28) described above. wherein the multidimensional data is obtained by using a flow cytometer to perform optical measurements of the plurality of cells.

(32)

At least one non-transitory computer-readable storage medium storing processor-executable instructions that, when executed by at least one hardware processor, cause the at least one hardware processor to perform:
receiving multidimensional data obtained from a plurality of cells;
clustering the multidimensional data to generate clustering results indicating a plurality of clusters including a first cluster and a second cluster that share at least a portion of the multidimensional data; and
outputting information representing reliability of the clustering results, wherein the information is indicative of a relationship between the first cluster and the second cluster.
   (33)

The at least one non-transitory computer-readable storage medium according to (32) described above, wherein outputting the information further comprises displaying a graphic illustrating the relationship between the first cluster and the second cluster.

(34)

The at least one non-transitory computer-readable storage medium according to (32) or (33) described above, wherein outputting the information further comprises displaying radar charts corresponding to clusters and a line enclosing radar charts corresponding to a group of clusters representing the first cluster, wherein the group of clusters includes the second cluster.

(35)

The at least one non-transitory computer-readable storage medium of according to any one of (32) to (34) described above, wherein the information representing reliability of the clustering results is obtained by determining a first evaluation value for the first cluster and a second evaluation value for the second cluster, and the information indicates a relationship between the first evaluation value and the second evaluation value.

(36)

A method, comprising:
receiving multidimensional data obtained from a plurality of cells;
clustering the multidimensional data to generate clustering results indicating a plurality of clusters including a first cluster and a second cluster that share at least a portion of the multidimensional data; and
outputting information representing reliability of the clustering results, wherein the information is indicative of a relationship between the first cluster and the second cluster.
   (37)

The method according to (36) described above, wherein outputting the information further comprises displaying a graphic illustrating the relationship between the first cluster and the second cluster.

(38)

The method according to (36) or (37) described above, wherein outputting the information further comprises displaying radar charts corresponding to clusters and a line enclosing radar charts corresponding to a group of clusters representing the first cluster, wherein the group of clusters includes the second cluster.

It should be understood by those skilled in the art that various modifications, combinations, sub-combinations and alterations may occur depending on design requirements and other factors insofar as they are within the scope of the appended claims or the equivalents thereof.

### REFERENCE SIGNS LIST

10 Measuring apparatus
20, 21 Information processing apparatus
30, 40 Terminal device
100 System
201 Input unit
203 Fluorescence separation unit
205 First clustering unit
207 Second clustering unit
209 Evaluation value calculator
211 Determination unit
213 Output unit
215 Clustering reconfiguration unit

1. An information processing apparatus comprising:
at least one hardware processor; and
at least one non-transitory computer-readable storage medium storing processor-executable instructions that, when executed by the at least one hardware processor, cause the at least one hardware processor to perform:
receiving multidimensional data obtained from a plurality of cells;
clustering the multidimensional data to generate clustering results indicating a plurality of clusters including a first cluster and a second cluster that share at least a portion of the multidimensional data; and
outputting information representing reliability of the clustering results, wherein the information is indicative of a relationship between the first cluster and the second cluster.

2. The information processing apparatus of claim 1, wherein the information representing reliability of the clustering results is obtained by determining a first evaluation value for the first cluster and a second evaluation value for the second cluster, and the information indicates a relationship between the first evaluation value and the second evaluation value.

3. The information processing apparatus of claim 2, wherein the first evaluation value is an index associated with a separation degree of the first cluster from at least some of the plurality of clusters.

4. The information processing apparatus of claim 2, wherein the first cluster corresponds to a set of detection events in the multidimensional data, and determining the first evaluation value further comprises determining a distance between individual detection events in the set and a center of the first cluster.

5. The information processing apparatus of claim 1, wherein the second cluster is obtained by integrating the first cluster with another cluster of the plurality of clusters.

6. The information processing apparatus of claim 5, wherein the relationship between the first evaluation value and the second evaluation value is that the first evaluation value is greater than the second evaluation value.

7. The information processing apparatus of claim 1, wherein the second cluster is obtained by dividing the first cluster into multiple clusters.

8. The information processing apparatus of claim 7, wherein the relationship between the first evaluation value and the second evaluation value is that the second evaluation value is greater than the first evaluation value.

9. The information processing apparatus of claim 1, wherein clustering the multidimensional data further comprises:
clustering the multidimensional data to generate a first group of clusters including the first cluster corresponding to a set of detection events in the multidimensional data; and
clustering the set of detection events to generate a second group of clusters including the second cluster.

10. The information processing apparatus of claim 9, wherein each in the set of detection events corresponds to measurement data obtained from one of the plurality of cells.

11. The information processing apparatus of claim 1, wherein outputting the information further comprises displaying a graphic illustrating the relationship between the first cluster and the second cluster.

12. The information processing apparatus of claim 1, wherein outputting the information further comprises displaying radar charts corresponding to clusters and a line enclosing radar charts corresponding to a group of clusters representing the first cluster, wherein the group of clusters includes the second cluster.

13. The information processing apparatus of claim 12, wherein outputting the information further comprises displaying a graphic where the radar charts are connected by lines, and wherein the radar charts corresponding to the group of clusters are connected to each other by at least some of the lines.

14. The information processing apparatus of claim 1, wherein the multidimensional data is indicative of fluorescence intensity spectrum obtained using a plurality of excitation wavelengths.

15. The information processing apparatus of claim 14, wherein the multidimensional data includes a fluorescence intensity spectrum for each of the plurality of excitation wavelengths.

16. The information processing apparatus of claim 1, wherein the multidimensional data is obtained by using a flow cytometer to perform optical measurements of the plurality of cells.

17. At least one non-transitory computer-readable storage medium storing processor-executable instructions that, when executed by at least one hardware processor, cause the at least one hardware processor to perform:
receiving multidimensional data obtained from a plurality of cells;
clustering the multidimensional data to generate clustering results indicating a plurality of clusters including a first cluster and a second cluster that share at least a portion of the multidimensional data; and
outputting information representing reliability of the clustering results, wherein the information is indicative of a relationship between the first cluster and the second cluster.

18. The at least one non-transitory computer-readable storage medium of claim 17, wherein outputting the information further comprises displaying a graphic illustrating the relationship between the first cluster and the second cluster.

19. A method, comprising:
receiving multidimensional data obtained from a plurality of cells;
clustering the multidimensional data to generate clustering results indicating a plurality of clusters including a first cluster and a second cluster that share at least a portion of the multidimensional data; and
outputting information representing reliability of the clustering results, wherein the information is indicative of a relationship between the first cluster and the second cluster.

20. The method of claim 19, wherein outputting the information further comprises displaying a graphic illustrating the relationship between the first cluster and the second cluster.
